(19) United States
(12) Patent Application Publication
(10) Pub. No.: US 2011/0282710 A1
(43) Pub. Date: Nov. 17, 2011

(54) ENTERPRISE RISK ANALYSIS SYSTEM

(75) Inventors: Rama K.T. Akkiraju, San Jose, CA (US); Indrajit Debroy, Bangalore (IN); Sweefen Goh, Hartsdale, NY (US); Nagesh K. Mantripragada, Bangalore (IN); Nitinchandra R. Nayak, Ossining, NY (US); Priya Prasad, Bangalore (IN); Pritish C. Senapati, Bangalore (IN); Manisha Srivastava, Bangalore (IN); Rajesh Suseelan, Bangalore (IN); Robert G. Torok, Toronto (CA); Juerg von Kaenel, Mahopac, NY (US)

(73) Assignee: INTERNATIONAL BUSINESS MACHINES CORPORATION, Armonk, NY (US)

(21) Appl. No.: 12/780,413

(22) Filed: May 14, 2010

(51) Int. Cl. G06Q 10/00

(52) U.S. Cl. 705/7.28; 705/301

(57) ABSTRACT

A system for analyzing enterprise risks is provided and includes a first subsystem to permit creation of enterprise risk management (ERM) templates and modification thereof into instances of searchable and retrievable ERM content, a second subsystem to permit visualization and editing of the ERM content, a plurality of integrated analysis tools and an ERM work product generator supported by the first and second subsystems to produce ERM analytical results and ERM work product based on the ERM content and a platform.

### BACKGROUND

Aspects of the present invention are directed to an enterprise risk analysis system.

Risk is the effect of uncertainty on objectives whether positive or negative. Risk management, therefore, refers to the identification, assessment, and prioritization of risks followed by coordinated and economical application of resources to minimize, monitor, and control the probability and/or impact of unfortunate events or to maximize the realization of opportunities.

For any given enterprise, be it public or private sector, prioritization and analysis are generally not supported with tools that can store, search, and retrieve related structured and unstructured information. Often, there is no support for collaboration to get multiple perspectives on identified and prioritized risks and no easy tools for allowing reuse of knowledge from previous or other risk identification, assessment, and prioritization exercises. Moreover, there are often no tools available to visualize an enterprise risk management (ERM) environment to understand relationships between risks, root causes, risk ownership, existing risk controls, and planned risk controls.

In fact, it is typical for risk related information to be merely stored and managed in spreadsheets and databases with limited search capabilities and limited reusability. In particular, the spreadsheets and databases do not easily support multi-dimensional filtered searches. Also, where compliance based selection of control process portfolio is employed, risks are not modeled in a meaningful manner. Thus, analysis of a control process portfolio without taking cost into account does not result in optimal resource allocation. Equally importantly, most risks cannot be managed solely or even primarily through compliance and control activities, but rather require the exercise of judgment which may not be validated (or proven wrong) for years or decades.

As an example, U.S. Pat. No. 7,603,283 to Spielmann discloses a system to identify levels of compliance for risks (but not risks themselves) against risk control procedures with the intent of making decisions regarding choice of risk control wherein non-compliance leads to accepting risk and creation of a risk response action plan. It deals only with quantitative information about each risk with a limited set of risk elements (risks, sub-risks, controls) and decisions are made by sorting compliance scores for each risk.

Similarly, U.S. Pat. No. 7,319,971 to Abrahams discloses a method of choosing a set of controls to bring residual risks within acceptable levels and uses a limited set of risk elements (generic risk record, profile risk record, risk management process script, risk context). The risk context comprises a profile containing related risks, associated consequences and controls and is used to organize the information required for computing inherent risk impact and identifying a set of controls to bring residual risk within acceptable levels.

### SUMMARY

In accordance with an aspect of the invention, a system for analyzing enterprise risks is provided and includes a first subsystem to permit creation of enterprise risk management (ERM) templates and population thereof into instances of searchable and retrievable ERM content, a second subsystem to permit visualization and editing of the ERM content, a plurality of integrated analysis tools and an ERM work product generator supported by the first subsystem for operation with the second subsystem to produce ERM analytical results and ERM work product based on the ERM content and a platform.

In accordance with another aspect of the invention, a system for analyzing enterprise risks is provided and includes a first subsystem, including an enterprise risk management (ERM) model designer to permit modeling of an ERM template including relationships thereof with other ERM templates, an ERM content editor to permit population of the ERM template into an instance of searchable and retrievable ERM content, an ERM content search module to permit searching of the ERM content and an ERM contextual collaboration platform to permit collaboration of ERM content editing, a second subsystem to permit visualization of the ERM content, a plurality of integrated analysis tools and an ERM work product generator supported by the first subsystem for operation with the second subsystem to produce ERM analytical results and other ERM work products based on the ERM content and a platform by which the first and second subsystems, the plurality of integrated analysis tools and the ERM work product generator are accessible to authorized users.

In accordance with another aspect of the invention, a computer-readable medium having a set of executable instructions stored thereon to cause a microprocessor of a computing device to implement a method for analyzing enterprise risks, the method including modeling an enterprise risk management (ERM) template, populating the ERM template into an instance of searchable and retrievable ERM content, visualizing the risk-related enterprise information, producing ERM analytical results and ERM work product based on the ERM content and providing via a platform authorized users with read/write access to the ERM template, the ERM content, the analytical results and the ERM work product.

### BRIEF DESCRIPTIONS OF THE SEVERAL VIEWS OF THE DRAWINGS

The subject matter regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 is a schematic view of a system for analyzing enterprise risk in accordance with an embodiment of the invention;

FIG. 2 is a schematic diagram of an exemplary enterprise risk management model in accordance with an embodiment of the invention;

FIG. 3 is a screenshot of a tool for analyzing enterprise risk in accordance with an embodiment of the invention;

FIG. 4 is a screenshot of an exemplary risk map in accordance with an embodiment of the invention;

FIG. 5 is a screenshot of an exemplary daisy-chain analysis in accordance with an embodiment of the invention;

FIG. 6 is a screenshot of an exemplary recommender module in accordance with an embodiment of the invention;

FIG. 7 is a screenshot of an exemplary heat map in accordance with an embodiment of the invention;

FIG. 8 is a schematic flow diagram illustrating an operation of the system of FIG. 1 in accordance with an embodiment of the invention;

FIG. 9 is a schematic view of a system for analyzing enterprise risk management capabilities in accordance with an embodiment of the invention; and

FIG. 10 is a schematic flow diagram illustrating an operation of the system of FIG. 4 in accordance with an embodiment of the invention.

### DETAILED DESCRIPTION

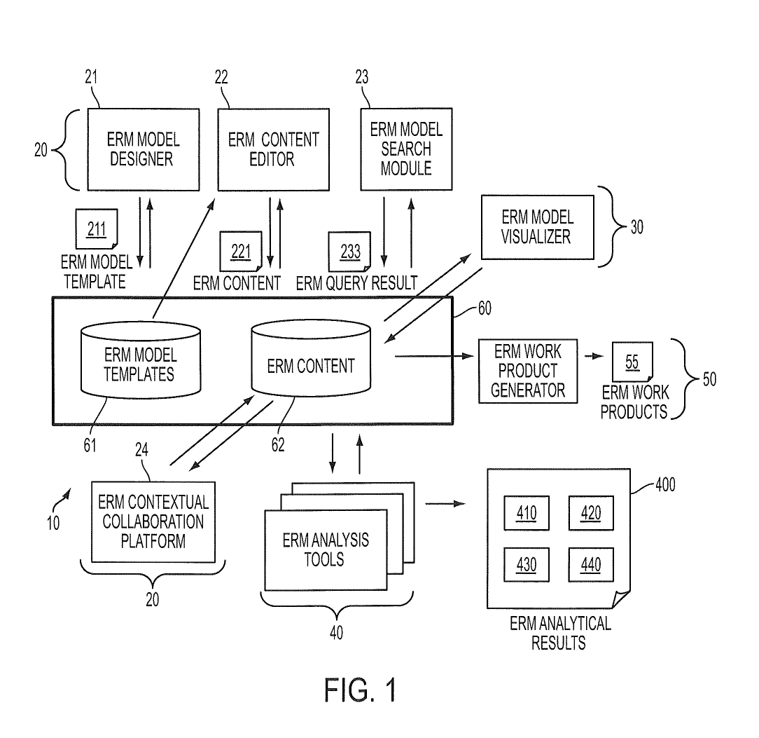

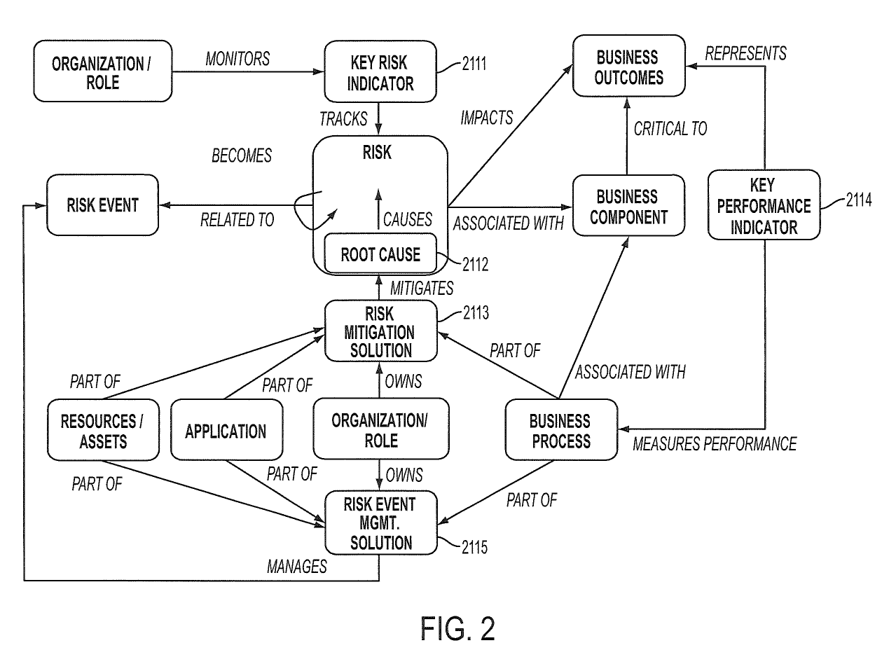

With reference to FIGS. 1 and 2, a system 10 for analyzing enterprise risks is provided. The system includes a first subsystem 20, a second subsystem 30, a plurality of analysis tools 40, an enterprise risk management (ERM) work product generator 50 and a platform 60 by which authorized users access the first and second subsystems 20 and 30, the plurality of analysis tools 40 and work product 55 output from the ERM work product generator 50.

The platform 60 may be any platform by which the authorized users communicate with one another and may include multiple clients and servers connected with one another, such as over the Internet, an Intranet, a wide area platform (WAN), a local area platform (LAN), etc. The platform 60 may include collaboration capabilities such as e-mail, ERM content rating, discussion forums to discuss ERM content, and facilities for sharing rich ERM documents of different kinds (images, videos, documents). The platform 60 may include hardware having storage capacity, such as a first repository 61 for storing ERM model templates 211 and a second repository 62 for storing ERM content 221. The platform 60 may include facilities to provide access control on the ERM content, facilities to visualize, query, search, and retrieve content and to rank the content based on various filters. At least one of the first and second repositories 61, 62 may maintain a historic record of risk response solutions and the associated risks. This historic record may includes effectiveness data regarding the effectiveness of previous risk responses and may assist in guiding the formation of future risk response strategies.

The first subsystem 20 includes an ERM model designer 21, an ERM content editor 22, an ERM model search module 23 and an ERM contextual collaboration platform 24. The ERM model designer 21 permits modeling of ERM model templates 211. Here, an authorized user may be granted read/write access to the first repository 61 by way of a client. With such access, the authorized user may build the ERM model template 211 or may review and, if necessary, modify or otherwise populate an existing ERM model template 211. The ERM model template 211 may include an identification and/or description of various ERM elements, such as risks, root causes, key risk indicators and metrics, risk controls, etc., along with the inter-relationships of a specific ERM element to other ERM elements.

The inter-relationships of ERM elements to other ERM elements are shown schematically in FIG. 2. As shown in FIG. 2, ERM elements, such as key risk indicators 2111, root causes 2112, risk mitigation solutions 2113, key performance indicators 2114 and risk event management solutions 2115 among others influence and are influenced by one another.

As an example, an ERM model template 211 may be built for a new product design team and an ERM element may be product failure due to faulty design. Here, the ERM model template 211 may indicate that the risk is product failure, the root causes are faulty design and/or insufficient instructions for product use, the key risk indicators are negative product test results and the risk controls are further engineering education for the design team and the use of design reviews. These ERM elements are related to each other to describe that the risk (product failure) has one or more root causes (faulty design and/or insufficient instructions for product use) that can be addressed by one or more risk controls (further engineering education for the design team and the use of design reviews). The risk (product failure) can be tracked using one or more key risk indicators (negative product test results).

Another type of risk to consider is the incapability of an enterprise to manage risk and could be applicable and relevant to various ERM model templates 211. If management lacks risk management maturity or the enterprise management structure does not encourage ownership of risk, it is not likely that the enterprise will respond appropriately to an unexpected or negative instance. Thus, the ERM model template 211 may indicate that the risk of product failure is compounded by the risk that management is unprepared to deal with an actual product failure and, as such, management's response will be inappropriate or inadequate. Here, the ERM model template 211 may indicate that a root cause of risk management incapability are lack of preparation or lack of risk ownership, the key risk indicators are the non-existence of company-wide risk management policies and the risk controls might include establishing and enforcing such policies.

The ERM content editor 22 permits modification of the ERM model template 211 into an instance of stored, organized, searchable and retrievable ERM content 221 that includes structured and unstructured risk-related enterprise information. Examples of structured risk-related enterprise information includes ERM risk, inherent risk likelihood and inherent risk impact. Examples of unstructured risk-related enterprise information includes risk description, ERM element related collaboration information (such as e-mail, ERM content rating, discussion forums to discuss ERM content) and attachments of rich documents of different kinds (images, videos, documents). An authorized user may be granted at least read access to the first repository 61 and read/write access to the second repository 62. With such access, the authorized user may review a particular ERM model template 211 and generate an instance of ERM content 221.

With respect to the examples given above, an instance of ERM content 221 may be the failure of an automatic shut off device for a power tool that could lead to severe injury of an end user. Here, the ERM content 221 may state that root causes of this type of failure are unreliable circuitry and the lack of sufficient testing, a key risk indicator is a similar failure in a similar device, and risk controls are an effort to improve design and the issuance of a warning label with the product. Similarly, another instance of related ERM content 221 may be the risk that company management will be incapable of appropriately responding to a case of an actual injury due to the product failure. Here, the root cause may be lack of preparation on the part of management, lack of ownership of risks associated with faulty design and the risk control may be the establishment of company-wide policies that prohibit products being brought to market having automatic shut off devices that are known to fail.

Each instance of ERM content 221 may be stored within the second repository 62 and, from there, the ERM content 221 is searchable via the ERM model search module 23. These searches may be keyword searches or filtered searches conducted at a client through application of multiple filters simultaneously and, as such, a user having been granted at least read access to the second repository 62 should be able to locate ERM content 221 he is interested in along with related ERM content 211 he may find useful for reference. An ERM search query result 233 is then provided to the user via the client. The searched ERM content 221 may also be ranked based on specific queries and, in an exemplary embodiment, risk response solutions may be ranked based on, for example, effectiveness in mitigating a given root cause.

The ERM contextual collaboration platform 24 is provided across a plurality of clients and is accessible to multiple users whereby the users can communicate with one another regarding the instances of ERM content 221. To that end, the ERM contextual collaboration platform 24 may support threaded discussions or blackboard forums, user specified ratings and/or email relating to the ERM content 221. In some cases, the ERM contextual collaboration platform 24 may further support online meetings during which ERM content 221 is discussed.

In accordance with some embodiments, information made available through the ERM contextual collaboration platform 24 may be extracted and incorporated into the ERM content 221. Here, for example, if a given risk is similar to a risk that has been considered and dealt with previously, the experience of the enterprise can inform the instance of ERM content 221 of the given risk. In that way, the enterprise can reuse information developed over time and improve its risk management capabilities.

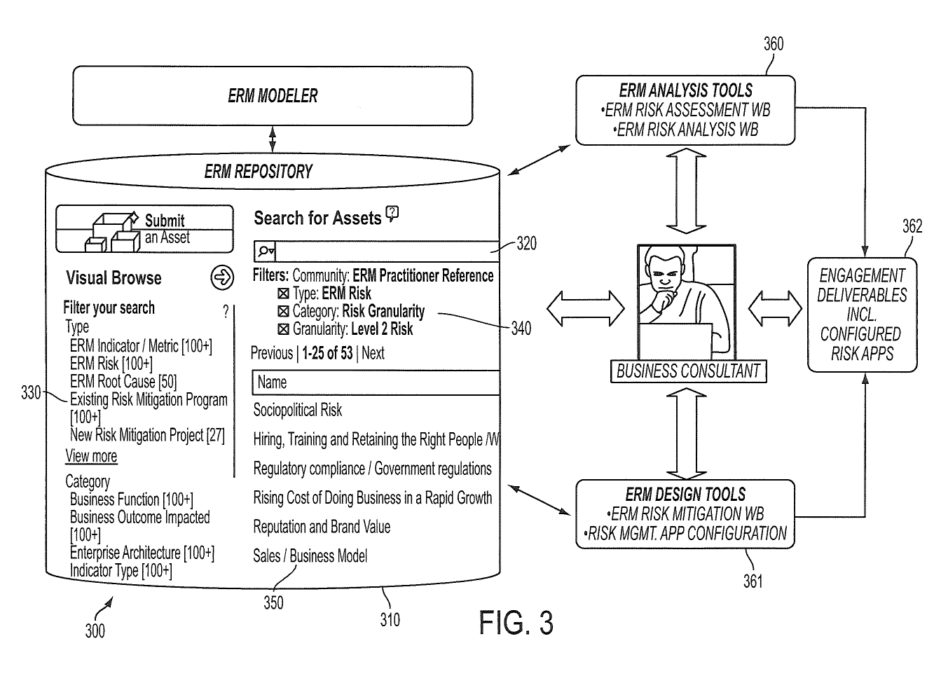

A second subsystem 30 permits visualization of the risk-related enterprise information developed via the first subsystem 20. With reference to FIG. 3, the second subsystem 30 may support a graphical user interface (GUI) 300 that is accessible via a client of the platform 60, which supports one or more of the ERM model designer 21, the ERM content editor 22, the ERM model search module 23 and the ERM contextual collaboration platform 24.

An exemplary screenshot 310 of the GUI 300 is shown in FIG. 3. As shown, the GUI 300 includes at least a keyword search field 320, filtered search options 330, applied filter information 340 and an ERM visual query result 350. The ERM visual query result 350 may include a listing of ERM content 221 matching the keyword/filtered searches already conducted and links to further visual representations of the ERM content 221. The GUI 300 thus provides the user, such as the business consultant of FIG. 3, access to the ERM content 221 as well as analysis tools 360, design tools 361 or risk applications 362 that may be helpful.

The first subsystem 20 and the second subsystem 30 may be provided with a semantic platform model that captures the enterprise risk-related content, such as risks, risk metrics, root causes, risk response solutions, business objectives, organizations, organizational role players and business processes, and their relationships. The semantic platform model may employ programming languages including Web Ontology Language (OWL), Resource Description Framework (RDF), HTML and XML for supporting the representation of the risk-related content and their relationships within the GUI 300 and, in some embodiments, may be embodied as a semantic reasoner, including a scalable highly expressive reasoner (SHER), Protégé and/or Pellet, to retrieve the relationships among various risk-related content elements.

With reference back to FIG. 1, the plurality of integrated analysis tools 40 support production of ERM analytical results 400 based on the ERM content 221, such as risk maps 410, risk prioritization modules 420, risk analysis modules 430 and recommender modules 440. Thus, the integrated analysis tools 40 facilitate the making of ERM decisions. The ERM work product generator 50 outputs ERM work products 500 from the ERM content 221.

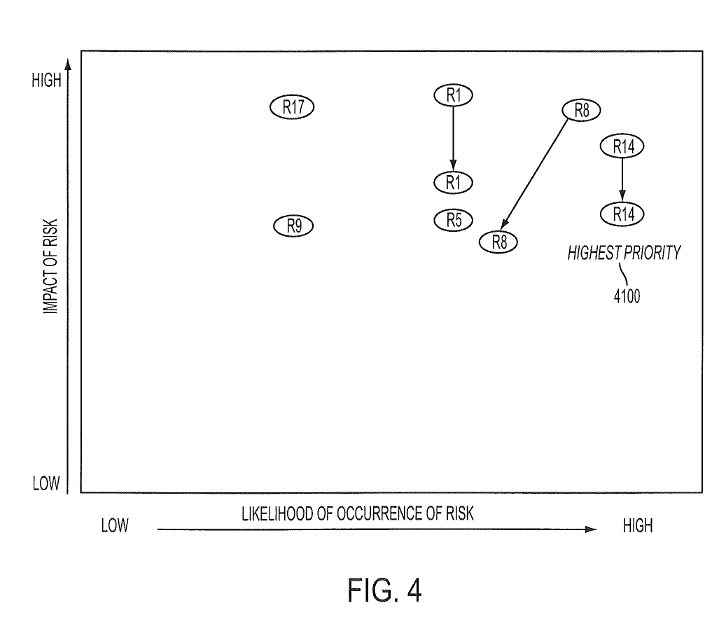

With reference to FIG. 4, an exemplary ERM risk map 410 visually presents a location of identified risks R1, R5, R8, R9, R14, R17 on a grid based on their likelihood of occurrence and the potential impact upon occurrence. The ERM risk map 410 may have varied granularity in terms of risk likelihood vs. timing. For example, the likelihood of a particular risk occurring may be low, medium-low, medium high or high whereas the impact of an occurrence is low, medium-low, medium high or high. Thus, a risk that is highly likely to occur in a given period of time that is also likely to have a high impact will be shown on the ERM risk map 410 as being highly prioritized. Conversely, a risk that is not likely to occur and is not likely to have a large impact will be shown as having a low priority. The ERM risk map 410 may be interactive such that users are permitted to manipulate the location of the risk based on input from one or more participants and manually mark the final position of each risk. Details 4100 associated with a specific risk can be accessed and edited by, for example, right-clicking.

A risk prioritization module 420 ranks risks based on plurality of criteria, including the likelihood of occurrence of risk and the impact of risk, and may produce a risk exposure estimate of individual risks computed using a plurality of techniques, including interviews with risk owners, preference elicitation and multi-criteria decision making approaches. Top risks are ranked based on the risk exposure estimate of each risk alone or by also including management's ability to influence the risk event's likelihood and/or impact.

A risk analysis module 430 enables both qualitative and quantitative analytics. Here, qualitative analytics refers to the analysis of non-quantified issues, such as the analysis of relationships between risks and risk causes or key risk indicators. Quantitative analytics refers to quantifiable analysis, such as the cost of risk mitigation versus the potential reduction in risk likelihood, risk impact or both.

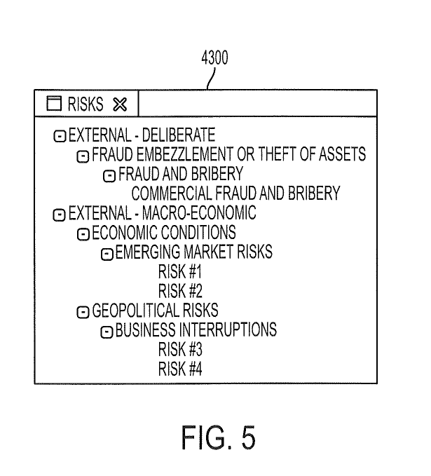

With reference to FIG. 5, which is an exemplary screenshot of a daisy-chain analysis 4300, it is seen how the analytics discussed above can be enabled by the risk analysis module 430. As shown in FIG. 5, various models of an enterprise are linked with one another (like a daisy-chain) and may be visualized. The daisy-chain analysis 4300 may be, therefore, a visual query that allows a user to explore business maps and understand relationships among business entities such as: risks, business components, metrics, business processes, and organizations. Using this daisy-chain analysis 4300, responsible business processes and organizations of a critical component can be identified and this information may be used to figure out, for example, who in which organization may be responsible for which business process/function. That person(s) may be later called upon for assistance with additional analytics.

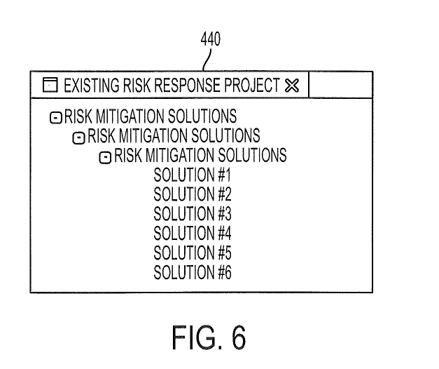

With reference to FIG. 6, a recommender module 440 provides recommendations on effective risk response solutions for addressing prioritized risks based on historic analysis of risk response solutions and may automatically identify shortfalls, including lack of organizational ownership of risks, absence of risk response solutions for specific risks and/or lack of identification of root causes. In particular, the recommender module 440 may suggest suitable risk response solutions, such as guideline training and development of training facilities as risk mitigation solutions, to mitigate prioritized risks. The recommender module 440 may further include a tool to automatically display the risk reduction potential of each risk control, sort the set of risk controls in descending order of its overall risk reduction potential, and display the impact on the user-specified budget of implementing each risk control.

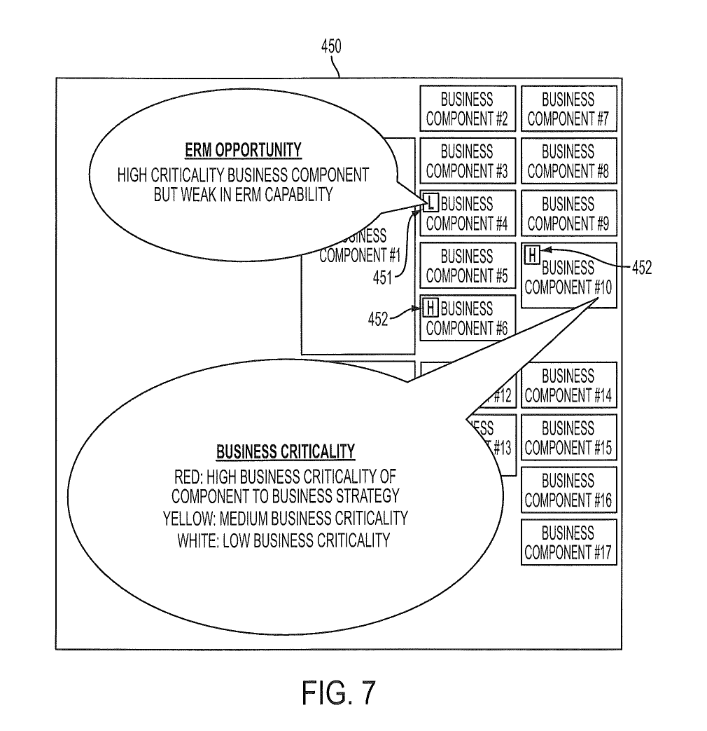

With reference to FIG. 7, the ERM analytical results 400 may be provided in an exemplary heat map 450. The heat map 450 may allow for analysis of different types of gaps in an enterprise's current risk management capabilities including: (a) ERM capability perception gaps between senior management/board executives and functional managers and (b) gaps between the reported and the desired ERM capabilities and (c) differences between the capabilities of different parts of the organization. This gap information may be presented as critical business functions/components instrumental in achieving the business objectives.

As shown in FIG. 7, business areas 451 may be color-coded based on their criticality to achieving business objectives. In addition, an annotation 452 may represent an ERM maturity gap computed by comparing assessed ERM capability with its desired target value. Thus, high criticality business areas that have high ERM maturity gaps are identified as prime candidates for further attention and improvement while business areas with good capabilities could be a source of organizational learning for weaker business areas.

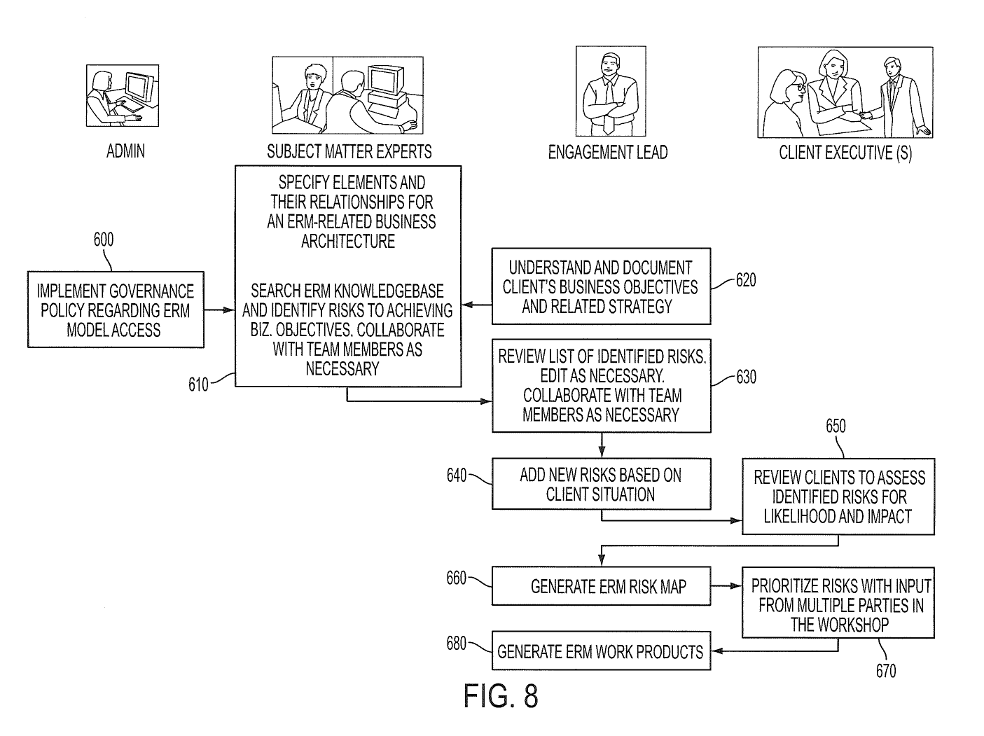

In an operation of the system 10, as shown in FIG. 8, an engagement lead understands and documents the client's business objectives and related strategy 620. Also, a system administrator can implement governance policy regarding ERM model access 600 for the engagement team members. Based on the client situation, the subject matter experts specify appropriate ERM elements and their relationships to create a client-specific ERM related business architecture 610. The ERM content can be either created from scratch or by searching through an ERM knowledgebase 610 to identify appropriate existing ERM content and customizing it for the client situation. In this process, they can review and edit identified ERM content including risks with collaboration with team members 630 and add new ERM content based on current conditions and/or the client situation 640. Client management can then review the identified risks to assess likelihood and impact 650 so that the engagement lead can generate a risk map 660. Finally, with the risk map as a reference, management can prioritize risks with input from multiple parties 670 and ERM work products 55 can be generated 680.

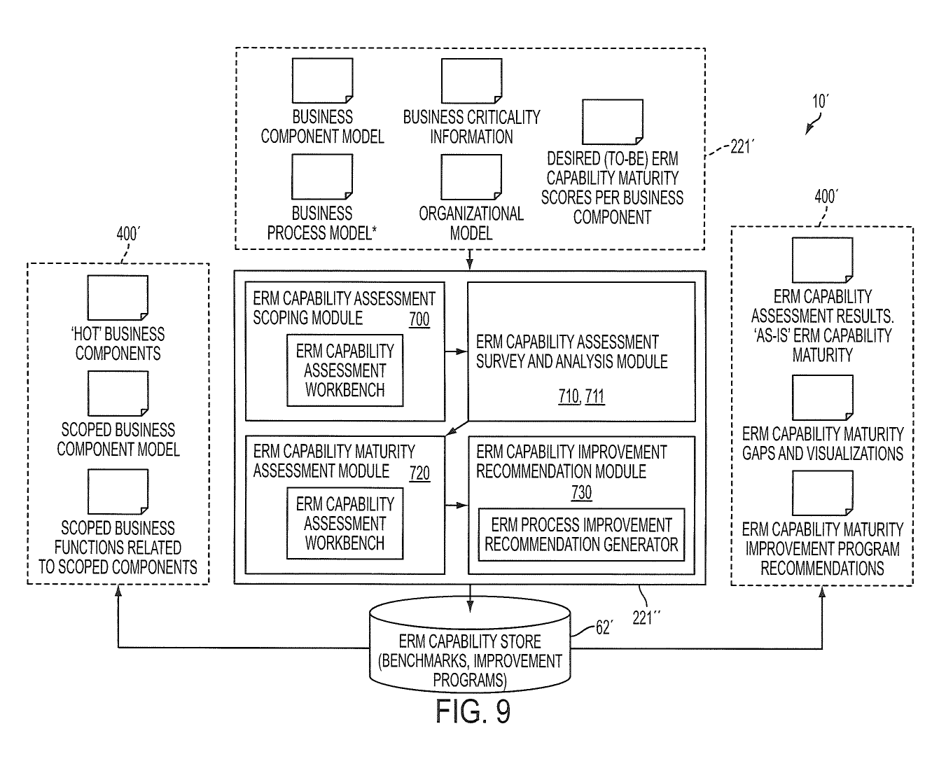

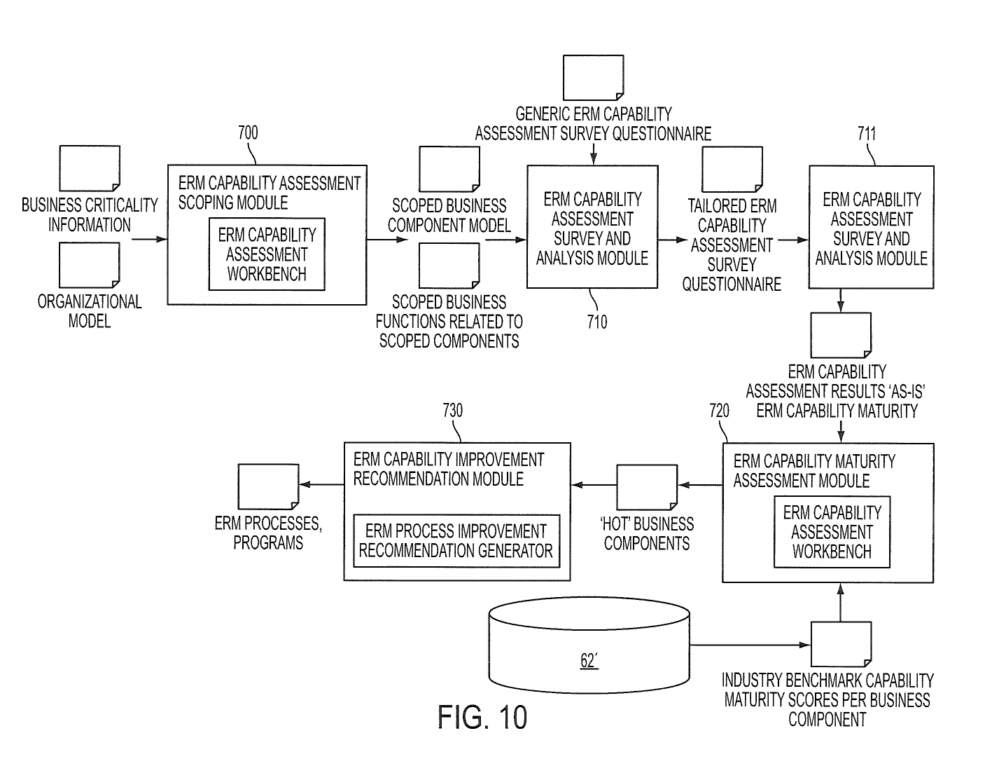

With reference to FIGS. 9 and 10, a system 10′ for analyzing enterprise risk management capabilities is provided. The system includes some of the features described above being employed for a specific type of risk analysis in which the capability of an enterprise to manage risk is assessed to thereby determine whether an enterprise risk management incapability or immaturity is itself a risk to be managed. Here, the ERM content 221′ may include a business component model, business criticality information, a business process model, an organizational model and desired ERM capability maturity scores per business component. In this way, the ERM content 221′ provides among other things a description of an enterprise structure, a description of its core functions and a description of desired ERM capability scores for each business component. The ERM analysis tool 221″ includes an ERM capability assessment scoping module 700, an ERM capability assessment survey and analysis module 710, 711, an ERM capability maturity assessment module 720, and an ERM capability improvement recommendation module 730 having an ERM process improvement recommendation generator. The output of the ERM analysis tool 221″ is stored in the ERM capability store (i.e., the second repository) 62′ and displayed to the user for decision making through visualization processor and work product generator 400′.

As shown in FIG. 10, a description of an organizational model and related business criticality information are inputted into the ERM capability assessment scoping module 700, which generates an output of a scoped business component model and scoped business functions related to scoped components. This output along with a generic ERM capability assessment survey questionnaire is inputted into the ERM capability assessment survey and analysis module 710, 711, which generates a tailored ERM capability assessment survey questionnaire that is distributed to the survey participants associated with the scoped business components within the client enterprise. The responses to that questionnaire are compiled by the ERM capability assessment survey and analysis module 710, 711, which then outputs ERM capability assessment results as an indication of “as-is” ERM capability maturity. The ERM capability assessment results along with desired capability maturity scores per business component, which are stored in the ERM capability store 62′, are inputted into the ERM capability maturity assessment module 720. The ERM capability maturity assessment module 720 identifies “hot” business components as representing ERM capability maturity gaps and visualizations and the ERM capability improvement recommendation module 730 generates ERM processes and programs accordingly to attempt to improve ERM capability maturity.

As such, a listing of the “hot” business components, a listing of the scoped business component model, a description of the scoped business functions related to the scoped components, the ERM capability assessment results, the ERM capability maturity gaps and visualizations and the ERM capability maturity improvement program recommendations are akin to ERM analytical results 400′. They can, therefore, be relied upon to identify areas where improvement is necessary and to identify, by comparison with the “hot” business components, where efforts taken towards improvement will have the greatest economic benefit.

In accordance with another aspect of the invention, the systems and methods described above may be embodied as a non-transitive computer-readable medium having a set of executable instructions stored thereon. When executed, the instructions are capable of causing a processing unit of a computing device to operate as the systems 10, 10′ or to execute any one of the methods.

In accordance with aspects of the invention, at least the first subsystem 20 and the plurality of the analysis tools 40 may be deployed by manual loading directly in client, server and proxy computers via a loading of a storage medium such as a CD, DVD, etc. The first subsystem 20 and the plurality of the analysis tools 40 may also be automatically or semi-automatically deployed into a computer system by being sent to a central server or a group of central servers from which they are then downloaded into the client computers for execution. Alternatively, the first subsystem 20 and the plurality of the analysis tools 40 may be sent directly to the client system via e-mail and then either detached to a directory or loaded into a directory by a button on the e-mail that executes a program that detaches the first subsystem 20 and the plurality of the analysis tools 40 into directories. Another alternative is to send the first subsystem 20 and the plurality of the analysis tools 40 directly to a directory on the client computer hard drive. When there are proxy servers, the process will, select the proxy server code, determine on which computers to place the proxy servers' code, transmit the proxy server code, then install the proxy server code on the proxy computer. The first subsystem 20 and the plurality of the analysis tools 40 will be transmitted to the proxy server and stored on the proxy server.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “system” or “subsystem.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A system for analyzing enterprise risks, the system comprising:
a first subsystem to permit creation of enterprise risk management (ERM) templates and population thereof into instances of searchable and retrievable ERM content;
a second subsystem to permit visualization and editing of the ERM content;
a plurality of integrated analysis tools and an ERM work product generator supported by the first subsystem for operation with the second subsystem to produce ERM analytical results and ERM work product based on the ERM content; and
a platform by which the first and second subsystems, the plurality of integrated analysis tools and the ERM work product generator are accessible to authorized users.

2. The system according to claim 1, wherein the first and second subsystems comprise a semantic platform model to capture and represent the ERM content.

3. The system according to claim 1, wherein the ERM content comprises ERM capability derived from responses to a distributed survey, measured on an ERM capability maturity scale and visualized in a context of a business criticality model.

4. The system according to claim 1, wherein the first subsystem comprises first and second repositories for storing the ERM template and the ERM content, respectively, which host structured and unstructured content organized for search and visual analysis.

5. The system according to claim 1, wherein the ERM content contains a plurality of attributes including rich content and is searchable by keyword searches and/or filtered searches.

6. The system according to claim 1, wherein the second subsystem permits specification of a scope on ERM content for visualization using a predefined risk taxonomy, wherein any ERM entity can be classified along multiple dimensions simultaneously.

7. The system according to claim 1, wherein at least one of the ERM analytical results and the ERM work product comprises user specified views on ERM content displayed as a semantic platform.

8. The system according to claim 1, wherein the first subsystem supports contextual collaboration features including discussion forums, tagging, rating and e-mail that allows multiple users to collaborate in the creation, visualization and analysis of risks.

9. The system according to claim 1, wherein at least one of the ERM analytical results and the ERM work product presents an editable risk prioritization map that can prioritize the risks based on a likelihood of occurrence and a potential impact.

10. The system according to claim 1, wherein the plurality of analysis tools comprises an automatic recommender module to suggest suitable risk response solutions to mitigate the prioritized risk.

11. The system according to claim 1, wherein the plurality of analysis tools comprises a risk exposure estimation tool using a plurality of techniques including interviews with risk owners, preference elicitation and multi-criteria decision making approaches.

12. The system according to claim 1, wherein the plurality of analysis tools comprises a tool to automatically identify various shortfalls including organizational shortfalls in dealing with risks, shortfalls in managing risk response programs and in identifying risk root causes.

13. The system according to claim 1, wherein the plurality of analysis tools comprises a tool to automatically display the risk reduction potential of each risk control, sort the set of risk controls in descending order of its overall risk reduction potential, and display the impact on the user-specified budget of implementing each risk control.

14. The system according to claim 1, wherein the ERM content is ranked based on queries to answer business related issues.

15. The system according to claim 1, wherein a repository maintains a historic record of risk response solutions and associated risks.

16. A system for analyzing enterprise risks, the system comprising:
a first subsystem, including an enterprise risk management (ERM) model designer to permit modeling of an ERM template including relationships thereof with other ERM templates, an ERM content editor to permit population of the ERM template into an instance of searchable and retrievable ERM content, an ERM model search module to permit searching of the ERM content and an ERM contextual collaboration platform to permit collaboration of ERM content editing;
a second subsystem to permit visualization of the ERM content;
a plurality of integrated analysis tools and an ERM work product generator supported by the first subsystem for operation with the second subsystem to produce ERM analytical results and ERM work product based on the ERM content; and
a platform by which the first and second subsystems, the plurality of integrated analysis tools and the ERM work product generator are accessible to authorized users.

17. The system according to claim 16, wherein the first and second subsystems comprise a semantic platform model to capture and represent the ERM content.

18. The system according to claim 16, wherein the ERM content comprises ERM capability derived from responses to a distributed survey, measured on an ERM capability maturity scale and visualized in a context of a business criticality model

19. A computer-readable medium having a set of executable instructions stored thereon to cause a microprocessor of a computing device to implement a method for analyzing enterprise risks, the method comprising:
modeling an enterprise risk management (ERM) template;
populating the ERM template into an instance of searchable and retrievable ERM content;
collaborating in the context of specific ERM content
visualizing and editing the risk-related enterprise information;
producing ERM analytical results and ERM work product based on the ERM content; and
providing via a platform authorized users with read/write access to the ERM template, the ERM content, the analytical results and the ERM work product.

20. The computer-readable medium according to claim 19, wherein the producing ERM analytical results comprises producing an ERM capability assessment with improvement program recommendations.
